(19) United States
(12) Patent Application Publication
(10) Pub. No.: US 2012/0181967 A1
(43) Pub. Date: Jul. 19, 2012

(54) PERMANENT MAGNET ELECTRIC MACHINE HAVING AN INTEGRATED MAGNETIC FLUX SENSOR

(75) Inventors: David A. Fulton, Anderson, IN (US); Bradley D. Chamberlin, Pendleton, IN (US)

(73) Assignee: REMY TECHNOLOGIES, L.L.C., Pendleton, IN (US)

(21) Appl. No.: 13/007,224

(22) Filed: Jan. 14, 2011

(51) Int. Cl. H02P 29/00; H02K 11/00; H02K 9/19

(52) U.S. Cl. 318/480; 310/53; 310/54; 310/68 B

(57) ABSTRACT

A permanent magnet electric machine that includes a housing, a stator mounted within the housing, a rotor assembly, a plurality of permanent magnets mounted within the rotor assembly, and a magnetic flux sensor arranged within the housing. The magnetic flux sensor includes a sensing surface configured and disposed to detect magnetic flux leaking from the rotor assembly.

### BACKGROUND OF THE INVENTION

Exemplary embodiments pertain to the art of permanent magnet electric machines and, more particularly, to a permanent magnet electric machine having an integrated magnetic flux sensor.

Electric machines produce work from electrical energy passing through a stator to induce an electro-motive force in a rotor. The electro-motive force creates a rotational force at the rotor. The rotation of the rotor is used to power various external devices. Of course, electric machines can also be employed to produce electricity from a work input. In either case, electric machines are currently producing greater outputs at higher speeds and are being designed in smaller packages. The higher power densities and speeds often result in harsh operating conditions such as high internal temperatures, vibration and the like. The high temperatures could result in break down of magnets in a permanent magnet electric machine. Accordingly, many conventional electric machines include sensors that monitor, for example stator temperature, housing temperature and the like. The sensors typically take the form of temperature sensors that are mounted to a housing of the electric machine.

### BRIEF DESCRIPTION OF THE INVENTION

Disclosed is a permanent magnet electric machine that includes a housing, a stator mounted within the housing, a rotor assembly, a plurality of permanent magnets mounted within rotor assembly, and a magnetic flux sensor arranged within the housing. The magnetic flux sensor includes a sensing surface configured and disposed to detect magnetic flux leaking from the rotor assembly.

Also disclosed is a method of operating a permanent magnet electric machine includes rotating a rotor assembly relative to a stator, sensing magnetic flux from the rotor assembly, and controlling a parameter of the electric machine based on the magnetic flux leaking from the rotor assembly.

### BRIEF DESCRIPTION OF THE DRAWINGS

The following descriptions should not be considered limiting in any way. With reference to the accompanying drawings, like elements are numbered alike:

FIG. 1 depicts an electric machine including an integrated magnetic flux sensor in accordance with an exemplary embodiment; and

FIG. 2 depicts an electric machine including an integrated magnetic flux sensor in accordance with another aspect of the exemplary embodiment.

### DETAILED DESCRIPTION OF THE INVENTION

A detailed description of one or more embodiments of the disclosed apparatus and method are presented herein by way of exemplification and not limitation with reference to the Figures.

Exemplary embodiments provide a magnetic flux sensor that is integrated directly into an electric machine. The magnetic flux sensor is positioned adjacent to magnets mounted in a rotor of a permanent magnet machine. The magnetic flux sensor provides feedback relating to flux leaking from the rotor. The flux density could be correlated to temperature of the magnets. Monitoring the temperature of the magnets enables a controller to adjust various operational parameters of the electric machine to enhance output and increase machine reliability by providing an indicator of a potential failure mode. That is, operating parameters, such as speed, load, motor back-EMF (electro-motive force) when operating in a generator mode, and/or coolant flow through the electric machine can be adjusted based on magnet temperature to avoid a potential demagnetization that could lead to machine failure.

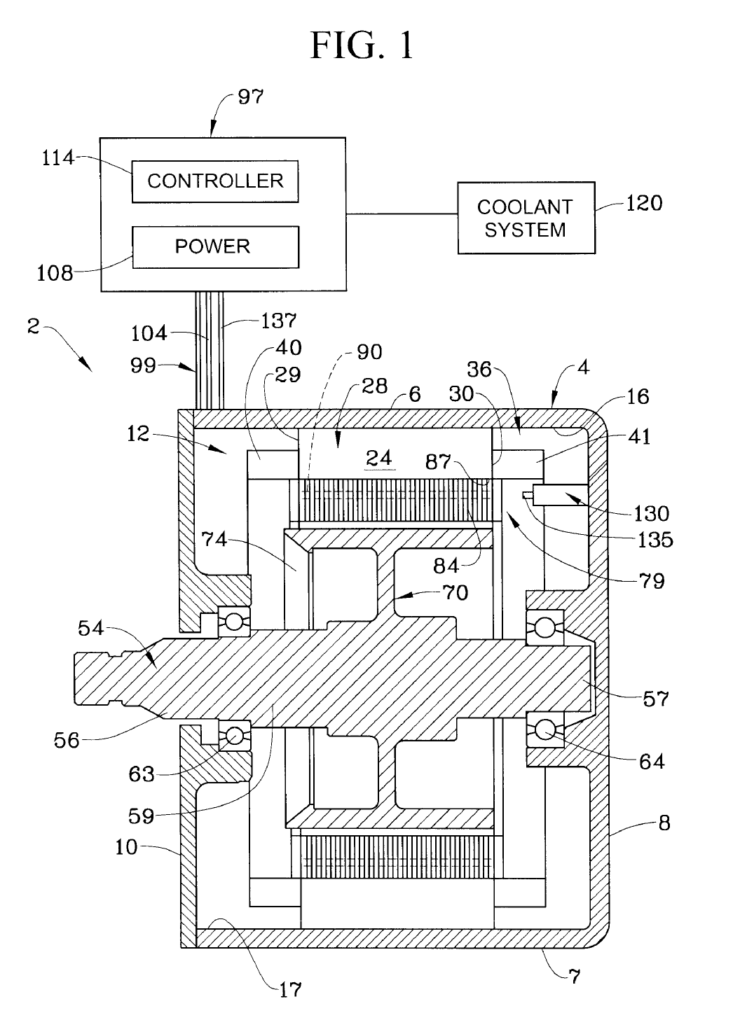

A permanent magnet electric machine in accordance with an exemplary embodiment is indicated generally at 2 in FIG. 1. Electric machine 2 includes a housing 4 having first and second side walls 6 and 7 that are joined by a first end wall 8 and a second end wall or cover 10 to collectively define an interior portion 12. First side wall 6 includes an inner surface 16 and second side wall 7 includes an inner surface 17. At this point it should be understood that housing 4 could also be constructed to include a single side wall having a continuous inner surface. Electric machine 2 is further shown to include a stator 24 arranged at inner surfaces 16 and 17 of first and second side walls 6 and 7. Stator 24 includes a body 28, having a first end portion 29 that extends to a second end portion 30, which supports a plurality of windings 36. Windings 36 include a first end turn portion 40 and a second end turn portion 41.

Electric machine 2 is also shown to include a shaft 54 rotatably supported within housing 4. Shaft 54 includes a first end 56 that extends to a second end 57 through an intermediate portion 59. First end 56 is rotatably supported relative to second end wall 10 through a first bearing 63 and second end 57 is rotatably supported relative to first end wall 8 through a second bearing 64. Shaft 54 supports a rotor assembly 70 that is rotatably mounted within housing 4. Rotor assembly 70 includes a hub 74 that is fixed relative to intermediate portion 59, and a rotor lamination assembly 79. Rotor lamination assembly 79 includes a plurality of laminations 84 that are stacked and aligned to define an outer diametric surface 87. Rotor lamination assembly 79 also includes a series of permanent magnets 90 embedded within the plurality of laminations 84.

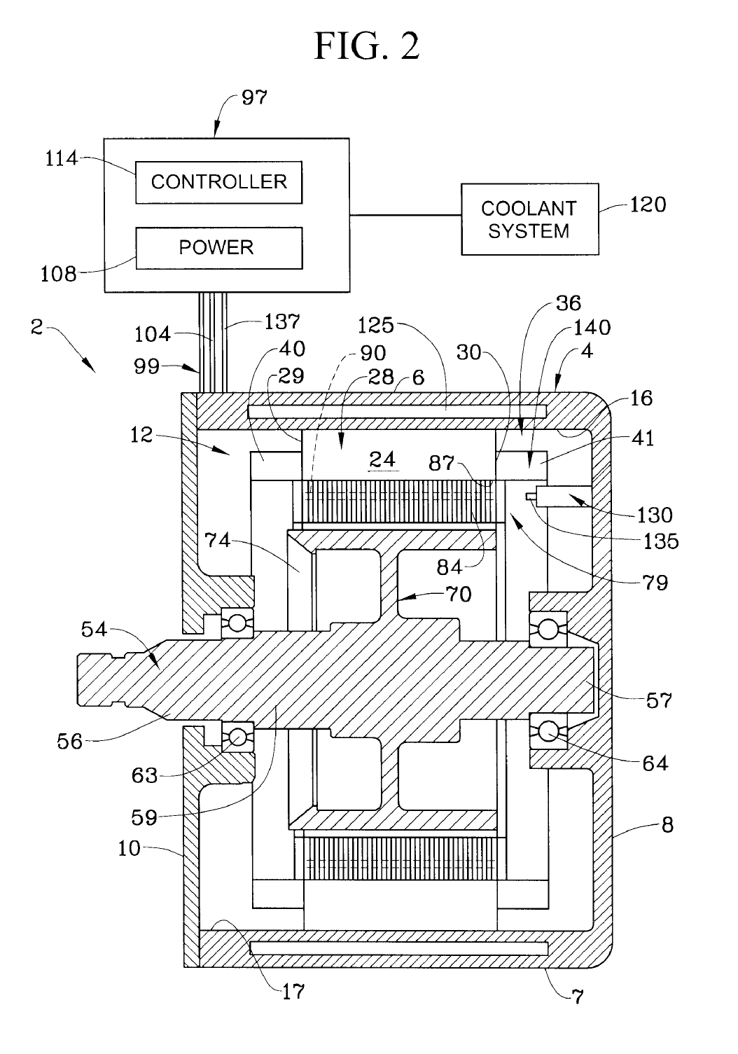

Electric machine 2 is electrically connected to a motor control panel 97 through a power cable 99 that includes a plurality of power conductors, one of which is indicated at 104, that electrically couple stator 24 with a power source 108 having terminals (not shown) arranged in motor control panel 97. Motor control panel 97 also houses a controller 114 that may be employed to control motor starting, motor speed, and/or motor shut down, as well as various other operating parameters as will be discussed more fully below. In the exemplary embodiment shown, controller 114 is linked to a coolant system 120 that delivers a flow of coolant, mixtures containing oil or glycol through housing 4. By “through” it should be understood that coolant system 120 can not only be configured to direct a flow of coolant directly into housing 4 and/or onto first and second bearings 63 and 64, but may also be configured to direct a flow of coolant onto first and second end turn portions 40 and 41 of stator 24, or indirectly through housing 4 such as through a water jacket 125 as shown in FIG. 2 wherein like reference numbers represent corresponding parts in the respective views.

In accordance with an exemplary embodiment, electric machine 2 includes a magnetic flux sensor 130, which, in the exemplary embodiment shown, is mounted to end wall 8 and directed toward permanent magnets 90 of rotor assembly 70. More specifically, magnetic flux sensor 130 includes a non-contact sensing surface 135 that is aligned with permanent magnets 90 of rotor assembly 70. In accordance with one aspect of the exemplary embodiment, magnetic flux sensor 130 takes the form of a Hall Effect sensor, however, it should be understood that other forms of magnetic flux sensing devices, such as a search coil, could be employed. Regardless of form, magnetic flux sensor 130 detects an amount or level of leakage magnetic flux emanating from rotor assembly 70. Sensor 130 may sense flux lines from permanent magnets 90 or from the plurality of laminations 84 depending upon a relative rotational position of senor 130 to rotor assembly 70. Magnetic flux sensor 130 sends a signal to controller 114 though a sensing line 137 indicating an amount of magnetic flux leaking from rotor assembly 70.

Controller 114 evaluates the signal and determines, based on the amount of magnetic flux, a temperature of permanent magnets 90. In this manner, controller 114 then controls a parameter of electric machine 2. For example, controller 114 controls coolant delivery in electric machine 2 based on magnet temperature to ensure that permanent magnets 90 do not break down. In addition to controlling coolant flow, controller 114 could also adjust electric machine speed, output power, output torque and/or reduce an amount of current flowing to the stator to lower heat loss. Also, by adjusting coolant flow to account for magnet temperature, controller 114 could reduce an amount of load or work required by external powered components such as pumps/fans and the like used to cool electric machine 2. Adjusting coolant flow to address cooling needs required by magnets when electric machine 2 is operated in either a motor mode or a generator mode will lead to a longer operational life for the electric machine. In addition to enhancing operational life, reducing the load otherwise utilized to operate auxiliary cooling components leads to an increase in operating efficiency.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof Therefore, it is intended that the invention not be limited to the particular embodiment disclosed as the best mode contemplated for carrying out this invention, but that the invention will include all embodiments falling within the scope of the claims.

What is claimed is:

1. A permanent magnet electric machine comprising:
a housing;
a stator mounted within the housing;
a rotor assembly rotatably mounted within the housing relative to the stator;
a plurality of permanent magnets mounted within the rotor assembly; and
a magnetic flux sensor arranged within the housing, the magnetic flux sensor including a sensing surface configured and disposed to detect magnetic flux leaking from the rotor assembly.

2. The permanent magnet electric machine according to claim 1, wherein the magnetic flux sensor is a non-contact temperature sensor.

3. The permanent magnet electric machine according to claim 2, wherein the non-contact temperature sensor is a Hall effect sensor.

4. The permanent magnet electric machine according to claim 2, wherein the non-contact temperature sensor is a search coil.

5. The permanent magnet electric machine according to claim 1, wherein the magnetic flux sensor is aligned with the plurality of permanent magnets.

6. The permanent magnet electric machine according to claim 1, further comprising: a coolant system configured and disposed to direct a flow of coolant to the electric machine.

7. The permanent magnet electric machine according to claim 6, further comprising: a water jacket extending about the housing.

8. The permanent magnet electric machine according to claim 6, wherein the coolant system directs the flow of coolant through the water jacket.

9. The permanent magnet electric machine according to claim 6, further comprising: a controller configured and disposed to deliver the flow of coolant through the housing based on magnetic flux sensed by the magnetic flux sensor.

10. The permanent magnet electric machine according to claim 9, wherein the controller is configured and disposed to determine a temperature of the plurality of permanent magnets based on the magnetic flux sensed by the magnetic flux sensor.

11. The permanent magnet electric machine according to claim 1, wherein the rotor assembly includes a plurality of laminations, the magnetic flux sensor being configured and disposed to detect magnetic flux leaking from the plurality of laminations.

12. The permanent magnet electric machine according to claim 1, wherein the magnetic flux sensor is configured and disposed to detect magnetic flux leaking from the plurality of permanent magnets.

13. A method of operating a permanent magnet electric machine, the method comprising:
rotating a rotor assembly relative to a stator;
sensing magnetic flux leaking from the rotor assembly; and
controlling a parameter of the electric machine based on the magnetic flux leaking from the rotor assembly.

14. The method of claim 13, wherein controlling the parameter of the electric machine comprises controlling a flow of coolant through the electric machine.

15. The method of claim 13, wherein controlling the parameter of the electric machine comprises controlling output power of the electric machine.

16. The method of claim 13, wherein controlling the parameter of the electric machine comprises controlling rotational speed of the electric machine.

17. The method of claim 13, wherein controlling the parameter of the electric machine comprises controlling output torque of the electric machine.

18. The method of claim 13, wherein sensing magnetic flux leaking from the rotor assembly comprises sensing magnetic flux leaking from a plurality of laminations of the rotor assembly.

19. The method of claim 18, wherein sensing magnetic flux leaking from the rotor assembly comprises sensing magnetic flux leaking from permanent magnets of the rotor assembly.

20. The method of claim 19, further comprising: determining a temperature of one or more of the permanent magnets in the rotor assembly based on the magnetic flux.
